(19) United States
(12) Patent Application Publication
(10) Pub. No.: US 2026/0044028 A1
(43) Pub. Date: Feb. 12, 2026

(54) SEMICONDUCTOR STRUCTURE FOR SILICON PHOTONICS AND METHOD FOR MANUFACTURING THE SAME

(71) Applicant: TAIWAN SEMICONDUCTOR MANUFACTURING COMPANY LTD., HSINCHU (TW)

(72) Inventors: WEI-JHIH MAO, TAIPEI CITY (TW); TSUNG-LIN HSIEH, HSINCHU CITY (TW); SHANG-YING TSAI, TAOYUAN CITY (TW); CHUN-HENG CHEN, HSINCHU CITY (TW); YINGKIT FELIX TSUI, CUPERTINO, CA (US)

(21) Appl. No.: 18/797,555

(22) Filed: Aug. 8, 2024

(51) Int. Cl. G02F 1/025; G02F 1/01

(52) U.S. Cl. CPC G02F 1/025; G02F 1/0147

(57) ABSTRACT

A semiconductor structure is provided. The semiconductor structure includes a substrate, a waveguide, a heating structure, a back-end-of-line (BEOL) structure, and a capping oxide structure. The waveguide is over the substrate. The heating structure is over the waveguide. The BEOL structure is over the waveguide. The capping oxide structure penetrates the BEOL structure and covers the heating structure. The capping oxide structure includes a continuous sidewall extended from a top side of the BEOL structure to a bottom side of the BEOL structure. A method for manufacturing a semiconductor structure is also provided.

### BACKGROUND

Micro heaters serve multiple functions in optical semiconductor structures. One of their primary roles is facilitating the thermal tuning of the optical properties of semiconductor devices. By locally heating specific regions of the device, such as waveguides or resonators, the refractive index or other optical parameters can be dynamically adjusted, allowing for wavelength tuning, mode control, or compensation for thermal drift.

For instance, some micro heaters can be utilized to adjust the refractive index of silicon waveguides to achieve dynamic wavelength tuning and improve coupling efficiency. In another example, some micro heaters are used to balance the arms of the Mach-Zehnder modulator (MZM), thus controlling the interference pattern for modulation or switching purposes. Furthermore, in the application of phase shifters, micro heaters in the phase shifters can alter the phase of light traveling through different paths, enabling reconfigurable optical circuits.

### BRIEF DESCRIPTION OF THE DRAWINGS

Aspects of the present disclosure are best understood from the following detailed description when read with the accompanying figures. It is noted that, in accordance with the standard practice in the industry, various structures are not drawn to scale. In fact, the dimensions of the various structures may be arbitrarily increased or reduced for clarity of discussion.

FIG. 1 illustrates a cross-sectional view of a semiconductor structure according to some embodiments of the present disclosure.

FIG. 2 illustrates a cross-sectional view of a semiconductor structure according to some embodiments of the present disclosure.

FIG. 3A illustrates a bottom view of a semiconductor structure according to some embodiments of the present disclosure.

FIG. 3B illustrates a cross-sectional view of the semiconductor structure along line AA′ in FIG. 3A according to some embodiments of the present disclosure.

FIG. 4A illustrates a bottomview of a semiconductor structure according to some embodiments of the present disclosure.

FIG. 4B illustrates a cross-sectional view of the semiconductor structure along line BB′ in FIG. 4A according to some embodiments of the present disclosure.

FIG. 5A illustrates a bottomview of a semiconductor structure according to some embodiments of the present disclosure.

FIG. 5B illustrates a cross-sectional view of the semiconductor structure along line CC′ in FIG. 5A according to some embodiments of the present disclosure.

FIG. 6A illustrates a bottomview of a semiconductor structure according to some embodiments of the present disclosure.

FIG. 6B illustrates a cross-sectional view of the semiconductor structure along line DD′ in FIG. 6A according to some embodiments of the present disclosure.

FIG. 7A illustrates a cross-sectional view of a semiconductor structure according to some embodiments of the present disclosure.

FIG. 7B illustrates a cross-sectional view of a semiconductor structure according to some embodiments of the present disclosure.

FIG. 7C illustrates a cross-sectional view of a semiconductor structure according to some embodiments of the present disclosure.

FIG. 7D illustrates a cross-sectional view of a semiconductor structure according to some embodiments of the present disclosure.

FIG. 8 illustrates a cross-sectional view of a semiconductor structure to show the requirements for using the capping oxide structure in the field of optical devices.

FIGS. 9A to 9C illustrate a simulation result of the equivalent (von-Mises) stress and temperature of a semiconductor structure that having a capping oxide structure over a waveguide and a heating structure.

FIGS. 10A to 10G illustrate cross-sectional views of a method for manufacturing a semiconductor structure according to some embodiments of the present disclosure.

FIG. 11 illustrates a flow chart of a method for manufacturing a semiconductor structure according to some embodiments of the present disclosure.

### DETAILED DESCRIPTION

The following disclosure provides many different embodiments, or examples, for implementing different features of the provided subject matter. Specific examples of elements and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper,” “on” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

As used herein, the terms such as “first”, “second” and “third” describe various elements, components, regions, layers and/or sections, these elements, components, regions, layers and/or sections should not be limited by these terms. These terms may be only used to distinguish one element, component, region, layer, or section from another. The terms such as “first”, “second”, and “third” when used herein do not imply a sequence or order unless clearly indicated by the context.

Micro heater can be applied in several silicon optical/photonics devices, serving functions in the modulation and control of optical signals. The use of the micro heater is based on the thermo-optic effect, wherein the refractive index of silicon changes with temperature. Accordingly, by precisely controlling the heat generated by the micro heater, the optical phase in the waveguide can be dynamically adjusted, enabling functionalities such as wavelength tuning, phase modulation, and compensation for thermal drift.

In practical applications, micro heaters are often integrated with optical components such as waveguides, for example silicon waveguide, which may be part of photonics devices like optical modulators or phase shifters. As mentioned above, localized heating can modify the refractive index of the silicon material, thus altering the propagation characteristics of light within the device. This process is essential for optimizing the performance of photonic integrated circuits (PICs), facilitating reconfigurable optical networks, and enhancing the precision of optical sensors.

However, achieving the desired optical phase tuning requires careful management of temperature. It is because higher temperatures can provide more substantial phase shifts but also introduce significant challenges. For example, elevated temperatures can lead to reliability issues such as thermal expansion mismatches and film cracking, which can degrade the device's performance and longevity. Therefore, the waveguide needs to be fabricated with higher accuracy and carefully designed to reduce the temperature tuning range to ensure the device's safety.

To provide more detail, in silicon photonics devices (e.g., modulators, phase shifters, etc.), the thermo-optic effect changes the material's refractive index during the heating of the waveguide, thereby altering the optical phase. One concern is determining the heating temperature to achieve sufficient optical phase change, which depends on the circuit design and application. In some cases, the heating temperature could exceed 500 degrees Celsius, which can induce reliability issues. For instance, the intermetal dielectric (IMD) films in the silicon photonics devices could crack under such high temperatures, allowing moisture to penetrate the circuit structure and cause functional failure. However, reducing the heater's operating temperature typically requires a more complicated photonic circuit design or more accurate fabrication control. Both approaches are challenging and incur additional costs, such as a larger design footprint or advanced processing techniques.

Therefore, some embodiments of the present disclosure provide a new approach to eliminate the reliability risks associated with the micro heater under high-temperature operation. In some embodiments, an oxide capping structure, which is purely composed of a single oxide material, is utilized to cover the top of the metal heater. This oxide capping structure may reduce the thermal stress induced by the mismatch of material properties in the IMD films in the semiconductor structure. Typically, each of the called IMD films is substantially a composite film/layer that includes various materials like TEOS oxide, low-k material, metal glue layer, and etching/CMP stop layer, among others. Each material has its own thermal and mechanical properties, which induce thermal stress, especially at the adhesion boundaries between adjacent sub-films/sub-layers in the IMD film when the temperature changes (i.e., during the heating of the waveguide).

To eliminate the differences in material properties and reduce thermal stress, some embodiments of the present disclosure remove all IMD films in the back-end of the line (BEOL) structure and refill such area with oxide material to cap the micro heater. The resulting oxide capping structure can alleviate the material property differences over the micro heater, thus alleviating the thermal stress. Simulation results show that the oxide capping design can also reduce the temperature from 495° C. to 420° C. (about a 15% reduction) and the thermal stress from 560 MPa to 300 MPa (about a 46% reduction) near the region in proximity to the micro heater. This advantage is result from the altered heat flow caused by the oxide capping, which has larger thermal resistance and forces the heat flow down to the silicon substrate, resulting in lower temperatures.

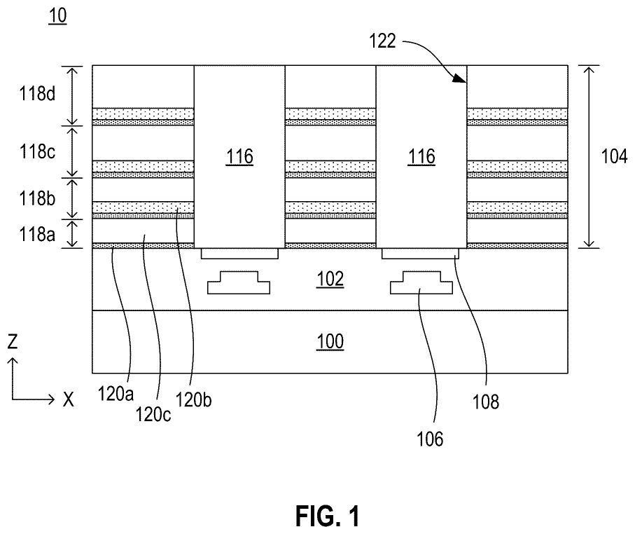

Referring to FIG. 1 of the present disclosure, in some embodiments, a semiconductor structure 10 includes a substrate 100, a pre-metal dielectric (PMD) 102 over the substrate 100, and a back-end-of-line (BEOL) structure 104 over PMD 102.

As the example shown in FIG. 1, the PMD 102 below the BEOL structure 104 can be a portion of the middle-end-of-line (MEOL) structure that includes dielectric material. The BEOL structure 104 may be an interconnect section that includes a metallization structure that has a plurality of metal layers (e.g., M1, M2 . . . , MX) electrically coupled by metal vias. The PMD 102 can be distinguished from the BEOL structure 104 by a number of process parameters, such as the choice of the fundamental material, or the choice of the metal used. For instance, the dielectric material of the PMD 102 can include low-k dielectric material with a small dielectric constant relative to silicon dioxide, and thus can be distinguished from the material of the substrate 100 and the BEOL structure 104; likewise, the metal usually used in the MEOL structure that surrounded by the for PMD 102 for electrical connect is tungsten (W), while the metal usually used in the first BEOL structure 104 is copper (Cu). These are several exemplary approaches to distinguish the stacked layers in the semiconductor structure 10.

In some embodiments, the semiconductor structure 10 can be an optical device based on the silicon photonics applications, such as an optical modulator or a phase shifter, which may include a waveguide (i.e., a semiconductor waveguide such as silicon waveguide) and a heating structure configured to elevate the temperature of the waveguide. In some embodiments, a waveguide 106 and a heating structure 108 are located within the PMD 102. The arrangement of the waveguide 106 and the heating structure 108 could be different form different types of optical device or different designs of each optical devices. In some embodiments, as the example shown in FIG. 1, in the scenario that the semiconductor structure 10 is an optical modulator, wherein the heating structure 108 is disposed over the waveguide 106.

In some embodiments, the waveguide 106 is configured to channel light with high precision and efficiency. The light can be confined and guided along a defined path by leveraging the high refractive index contrast between silicon and its surrounding cladding materials (e.g., silicon dioxide or silicon nitride). This contrast allows for tight confinement of the optical mode, enabling compact and high-density photonic circuits. The waveguide's dimensions are meticulously designed, often on the order of hundreds of nanometers, to ensure single-mode operation and minimize losses.

In some embodiments, the heating structure 108 is disposed correspondingly to the waveguide 106 for fine-tuning the optical properties of the waveguide 106 based on the thermo-optic effect in silicon. In some embodiments, the heating structure 108 is made of metal, such as a tungsten (W). In some embodiments, the heating structure 108 may have a shape in a micro ring type or a liner type, which will be further described later.

In some embodiments, the waveguide 106 and the heating structure 108 are in proximity to two opposite sides of the PMD 102. In some embodiments, the heating structure 108 is in proximity to a top side of the PMD 102. In some embodiments, the heating structure 108 is substantially coplanar with a top surface of the PMD 102. In some embodiments, the heating structure 108 is at least projectively over a region of the waveguide 106 that needs to be heated.

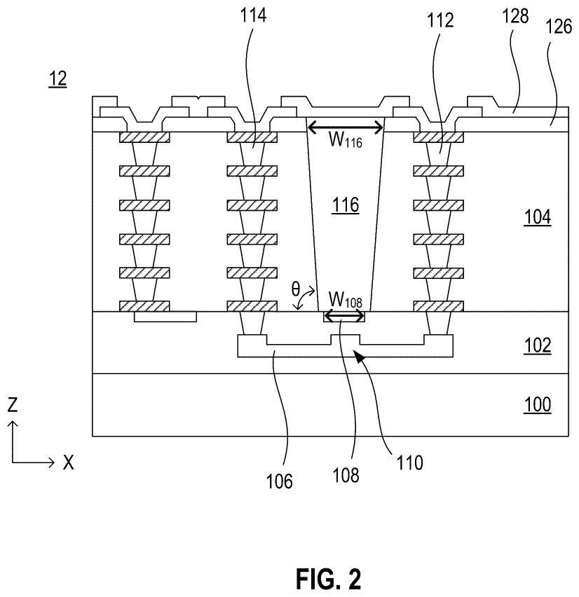

For example, as shown in FIG. 2, in some embodiments, the waveguide 106 in a semiconductor structure 12 includes a PN junction 110. In some embodiments, the semiconductor structure 12 further includes a first type electrode 112 connected to a side of the waveguide 106, and a second type electrode 114 connected to another side of the waveguide 106. In these embodiments, or similar ones, the heating structure 108 does not cover the entire waveguide 106; rather, only a portion of the waveguide 106, such as the PN junction 110, is covered by the heating structure 108 from a cross-section view perspective of the semiconductor structure 12.

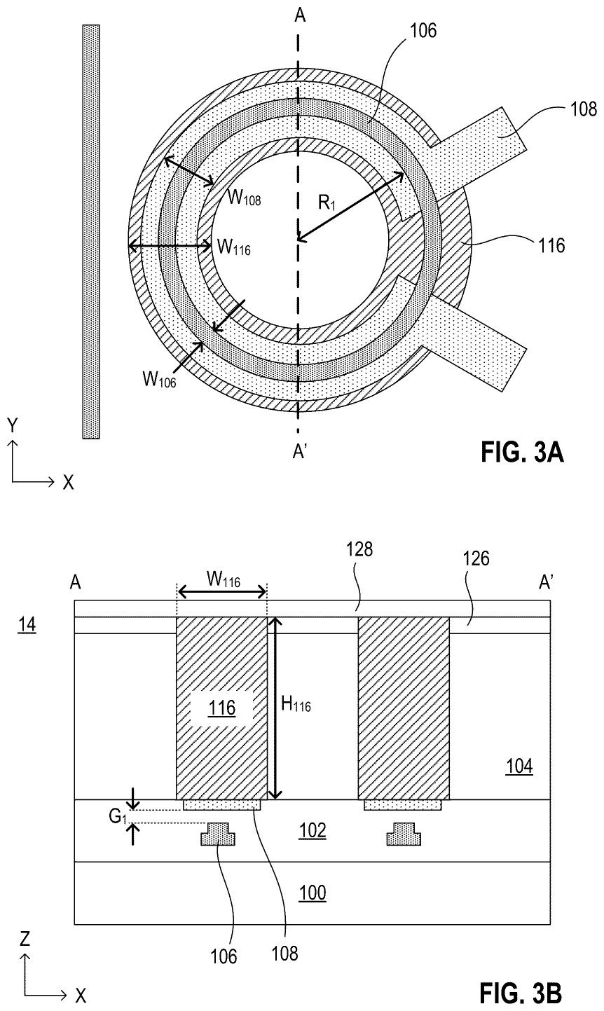

In some embodiments, the waveguide 106 and the heating structure 108 are separated from each other by the PMD 102. The separation of the waveguide 106 and the heating structure 108 is based on the concern of the optical performance. In some embodiments, a gap G₁ (as shown in FIG. 3B) between the waveguide 106 and the heating structure 108 is in a range from about 0.7 μm to about 1.0 μm.

Referring to FIGS. 1 and 2, the BEOL structure 104 over the PMD 102 can have a capping structure penetrating the BEOL structure 104 and covering the heating structure 108. In some embodiments, the capping structure includes a capping oxide structure 116. The capping oxide structure 116 is substantially a bulk oxide embedded in the BEOL structure 104, without having any conductive materials therein. In some embodiments, a width W₁₁₆ of the capping oxide structure 116 is greater than a width W₁₀₈ of the heating structure 108 below the capping oxide structure 116. Therefore, the heating structure 108 is substantially shielded by the capping oxide structure 116 within the region where the capping oxide structure 116 is formed. In other words, since the power of the heating structure 108 typically comes from an electrical current passing through the material of the heating structure 108, and the electrical resistance of the heating structure 108 converts electrical energy into thermal energy due to the Joule heating effect to heat the nearby waveguide 106, the position and coverage of the capping oxide structure 116 is substantially determined to be aligned with the region that the heating structure 108 is configured to heat. The capping oxide structure 116 is disposed over the heating structure 108 to reduce the possibility of structural failure due to the heat. Thus, the width W₁₁₆ of the capping oxide structure 116 is at least greater than the width W₁₀₈ of the heating structure 108 to account for etching bias.

In some embodiments, the width W₁₁₆ of the capping oxide structure 116 is greater than the width W₁₀₈ of the heating structure 108 in a range from about 1.0 μm to about 2.0 μm.

In some embodiments, the capping oxide structure 116 includes a single type of material and is free from having conductive material. In some embodiments, the material of the single type of material includes tetra-ethyl-ortho-silicate (TEOS), undoped silicate glass (USG), phosphor-silicate glass (PSG), or high-density plasma (HDP) oxide. In some embodiments, the material of the capping oxide structure 116 can further include CVD oxides that have good gap-filling capabilities.

Referring to FIGS. 3A and 3B, which illustrate a bottom view and a cross-section view along line AA′ of a semiconductor structure 14 that has the heating structure 108 with a type of micro ring metal heater. In this embodiment, a rounded portion of the heating structure 108 is used to heat the waveguide 106, which has a round profile. The profile of the capping oxide structure 116 is substantially conformal to the round profile of the waveguide 106 and the rounded portion of the heating structure 108. In some embodiments, the round profile of the waveguide 106, the rounded portion of the heating structure 108, and the profile of the capping oxide structure 116 are concentric circles from a bottom view perspective, with the profile of the capping oxide structure 116 covering the first two.

In some embodiments, like the example shown in FIGS. 3A and 3B, an inner radius R₁ of the waveguide 106 is in a range from about 10 μm to about 30 μm. In some embodiments, a width W₁₀₆ of the waveguide 106 is in a range from about 200 nm to about 300 nm. In some embodiments, the width W₁₀₈ of the heating structure 108 is in a range from about 3 μm to about 5 μm. These are some examples of the typical optical devices that have waveguide and heating structure, and the ranges can be altered based on the design rule and the specification requirement of the optical devices. Corresponding to the size of the heating structure 108, in some embodiments, the width W₁₁₆ of the capping oxide structure 116 is in a range from about 4 μm to about 6 μm. In some embodiments, a height H₁₁₆ of the capping oxide structure 116 is in a range from about 6 μm to about 8 μm. In some embodiments, the height of the capping oxide structure 116 is substantially identical to a thickness of the BEOL structure 104. In some embodiments, an aspect ratio of the capping oxide structure 116 is no greater than about 5. In some embodiments, an aspect ratio of the capping oxide structure 116 is no greater than about 3. The upper limit of the aspect ratio of the capping oxide structure 116 is based on manufacturing technique restrictions.

Furthermore, in some embodiments, an angle θ (shown in FIG. 2) between the PMD 102 and a sidewall of the capping oxide structure 116 is in a range from about 80 degrees to about 90 degrees.

In some embodiments, the BEOL structure 104 includes a plurality of inter metal dielectric (IMD) layers 118 (i.e., 118a, 118b, 118c, 118d, etc.) Since each of these IMD layers are substantially a composite film/layer that includes various materials like TEOS oxide, low-k material, metal glue layer, and etching/CMP stop layer, or the like, the material properties of the sub-layer/sub-film in each of the IMD layers can be dramatically different. For example, a first material for forming a first sub-layer 120a in the IMD layer 118a may have an elastic modulus at about 465 GPa, whereas a second sub-layer 120b in the IMD layer 118b may have an elastic modulus at about 73 GPa, and a third sub-layer 120c in the IMD layer 118a may have an elastic modulus at about 22.1 GPa. Likewise, the first sub-layer 120a in the IMD layer 118a may have a coefficient of thermal expansion (CTE) at about 2.2×10⁻⁶/°C., whereas the second sub-layer 120b in the IMD layer 118b may have a CTE at about 5.5×10⁻⁷/°C., and the third sub-layer 120c in the IMD layer 118a may have a CTE at about 1.4×10⁻⁵/°C. Moreover, the first sub-layer 120a in the IMD layer 118a may have a thermal conductivity coefficient at about 200 W/mk, whereas the second sub-layer 120b in the IMD layer 118b may have a thermal conductivity coefficient at about 1.3 W/mk, and the third sub-layer 120c in the IMD layer 118a may have a thermal conductivity coefficient at about 100 W/mk. That is, the sub-layers within a single IMD layer may consist of materials that differ from each other in various aspects.

The capping oxide structure 116 in some embodiments of the present disclosure is formed in the BEOL structure 104 and penetrates the BEOL structure 104 accordingly. Therefore, the capping oxide structure 116 is different from a dielectric section within one of the IMD layer in the BEOL structure 104 or a stack of such dielectric sections among a plurality of IMD layers 118 in the BEOL structure 104. In some embodiments, the capping oxide structure 116 includes a continuous sidewall 122 extended from a top side of the BEOL structure 104 to a bottom side of the BEOL structure 104. In some embodiments, a side of each of the IMD layers 118 in the BEOL structure 104 is in contact with the continuous sidewall 122 of the capping oxide structure 116.

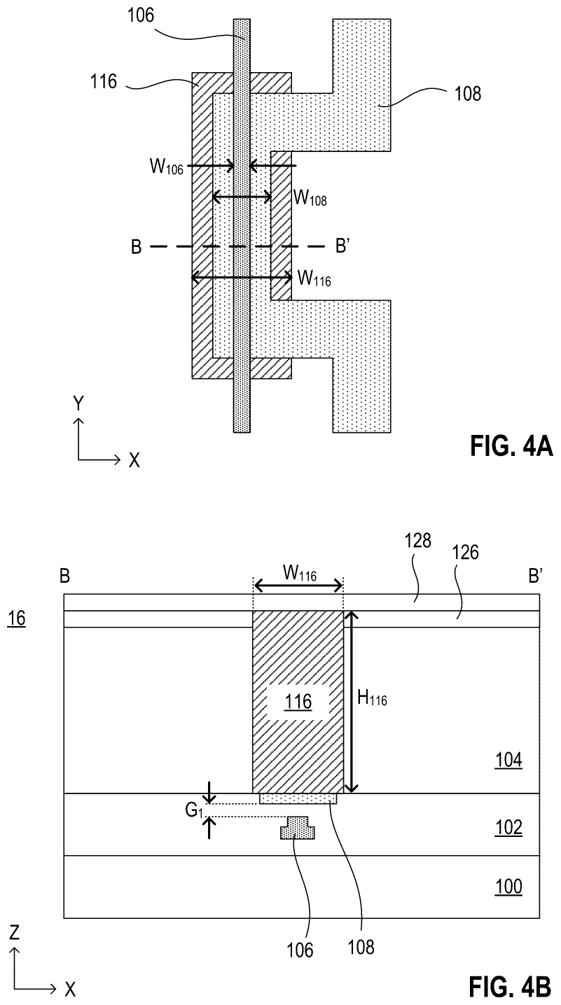

Referring to FIGS. 4A and 4B, which illustrate a bottom view and a cross-section view along line BB′ of a semiconductor structure 16 that has the heating structure 108 with a type of liner metal heater. In this embodiment, a liner portion of the heating structure 108 is used to heat the waveguide 106, which has a liner profile. Compared to the embodiments previously shown in FIGS. 3A and 3B, the profile of the capping oxide structure 116 is also substantially conformal to the profile of the waveguide 106 and the heating portion of the heating structure 108. That is, the capping oxide structure 116 disclosed in some embodiments of the present disclosure can be widely used in various waveguides and heating structures with different geometries.

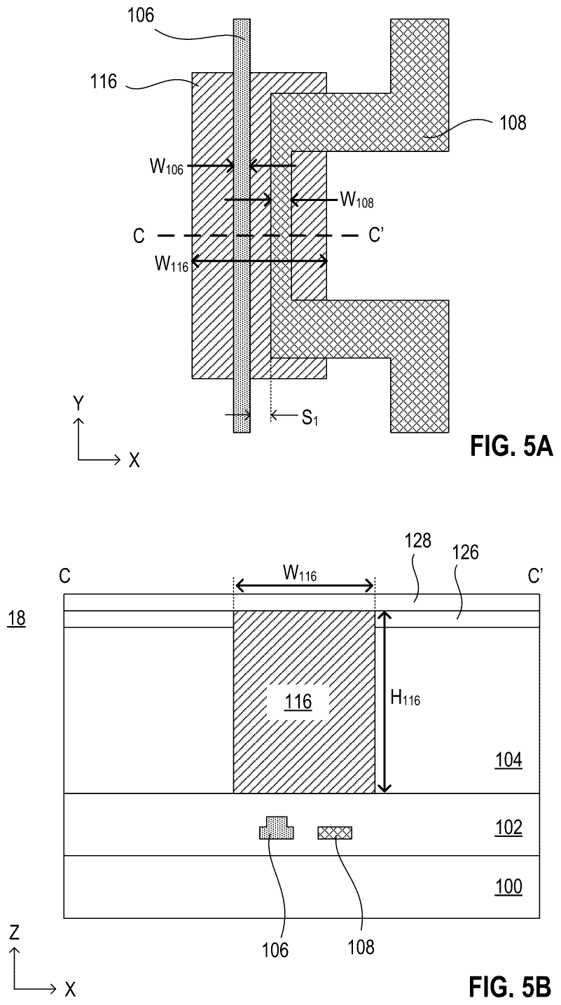

Referring to FIGS. 5A and 5B, which illustrate a bottom view and a cross-section view along line CC′ of a semiconductor structure 18 that has the heating structure 108 in a form of poly silicon heater. In these embodiments, the heating structure 108 can be disposed in the PMD 102 and adjacent to the waveguide 106. In some embodiments, the waveguide 106 is laterally adjacent to the heating structure 108 in the PMD 102. In some embodiments, the waveguide 106 is level with the heating structure 108 in the PMD 102.

In the example shown in FIGS. 5A and 5B, because the waveguide 106 and the heating structure 108 are not arranged vertically, the width W₁₁₆ of the capping oxide structure 116 can be much greater than each of the width W₁₀₆ of the waveguide 106 and the width W₁₀₈ of the heating structure 108, in order to cover both the waveguide 106 and the heating structure 108. Hence, in some embodiments, the width W₁₀₆ of the waveguide 106 is in a range from about 200 nm to about 300 nm and the width W₁₀₈ of the heating structure 108 is in a range from about 200 nm to about 300 nm, while the W₁₁₆ of the capping oxide structure 116 is greater than about 2 μm. In these embodiments, the height H₁₁₆ of the capping oxide structure 116 is in a range from about 6 μm to about 8 μm, and the aspect ratio of the capping oxide structure 116 is no greater than about 3, or to about due to the manufacturing technique restrictions. In some embodiments, a space S₁ between the waveguide 106 and the heating structure 108 is in a range from about 0.7 μm to about 1.0 μm. The space S₁ and the gap G₁ in other embodiments are utilized to ensure that the waveguide 106 and the heating structure 108 are not too close to impact the optical performance.

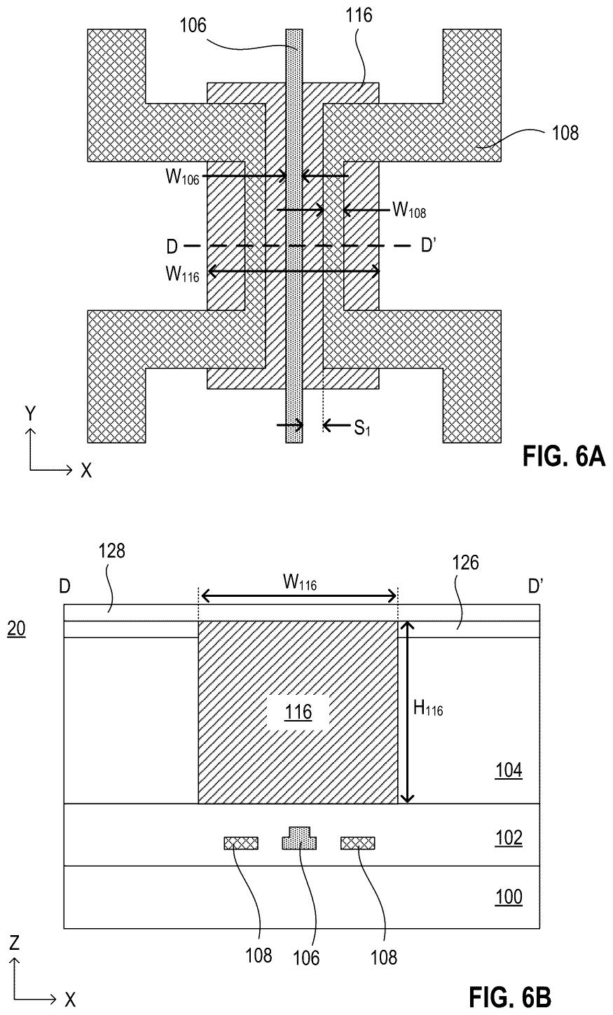

Referring to FIGS. 6A and 6B, which illustrate a bottom view and a cross-section view along line DD′ of a semiconductor structure 20 that not only has the heating structure 108 in a form of poly silicon heater, but the heating structure 108 includes two poly silicon heaters 108a and 108b in proximity to two sides of the waveguide 106, and the width W₁₁₆ of the capping oxide structure 116 is greater than a width of a region including the two poly silicon heaters. Compared to the embodiments previously shown in FIGS. 5A and 5B, the capping oxide structure 116 can be wider than that in those embodiments, since another poly silicon heater will be covered by the capping oxide structure 116.

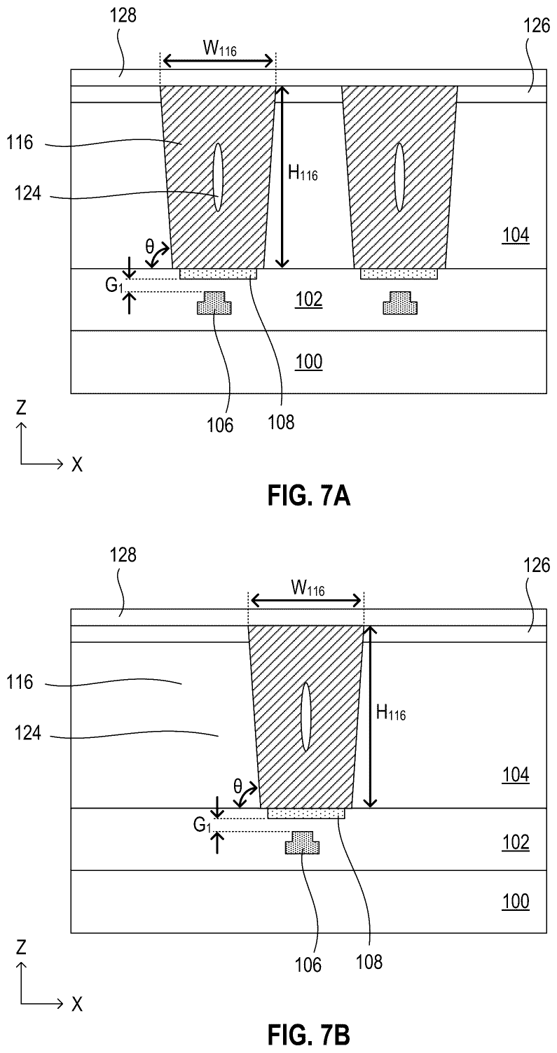

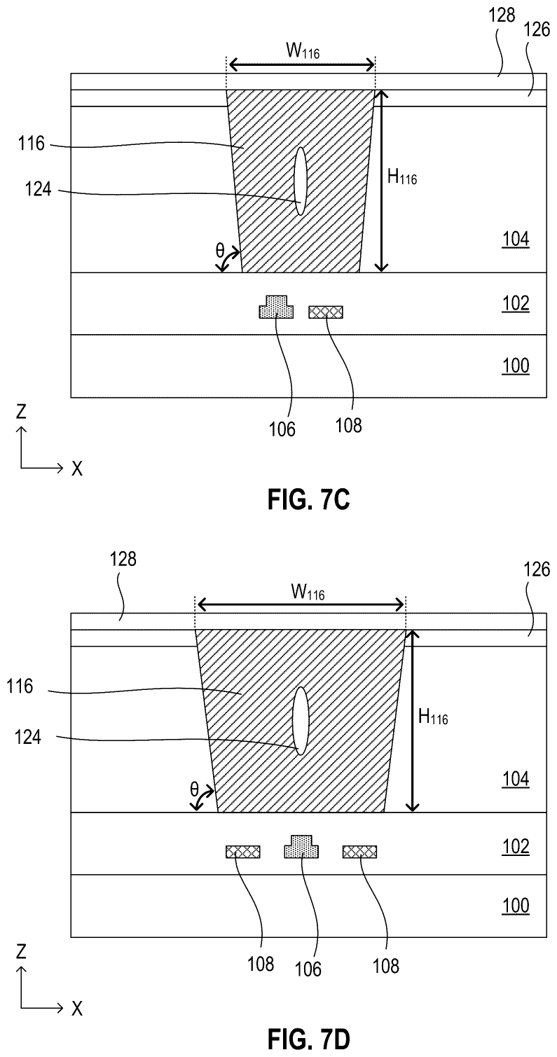

Referring to FIGS. 7A to 7D, in some embodiments, the capping oxide structure 116 includes at least a void 124 (or a seam) in proximity to a centerline of the capping oxide structure 116 from a cross-section view perspective. The void 124 can be formed through the control of the deposition process of the material of the capping oxide structure 116. The void 124 can be used to reduce the surrounding parasitic capacitance and improve the resistive-capacitive (RC) time delay. As shown in these embodiments, the presence of void 124 in the capping oxide structure 116 does not impact its application across various schemes of arrangement and types of waveguides and heating structures covered by the capping oxide structure 116.

Moreover, in some embodiments, the semiconductor structure in the present disclosure can further include a silicon nitride layer 126 is disposed over the BEOL structure 104. In some embodiments, a top surface of the silicon nitride layer 126 is coplanar to a top surface of the capping oxide structure 116. In some embodiments, a passivation layer 128 is disposed over the silicon nitride layer 126 and the capping oxide structure 116. In some embodiments, one or more under bump metallization (UBM) can be formed at the silicon nitride layer 126, and these UBM made of conductive materials such as AlCu, can be laterally adjacent to a top portion of capping oxide structure 116.

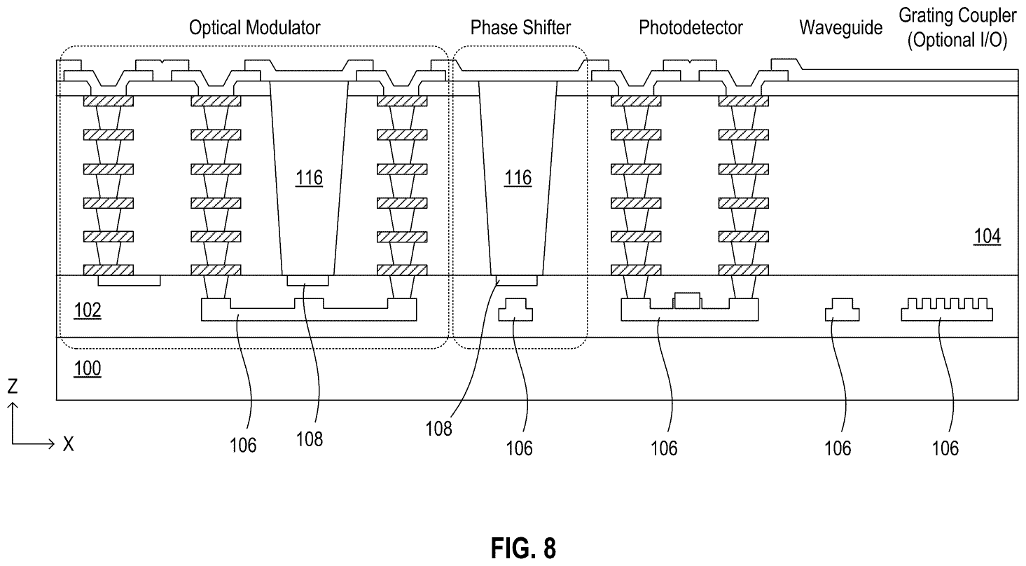

Referring to FIG. 8, which illustrates the requirements for using the capping oxide structure in the field of optical devices. These optical devices are drawn in a single diagram to facilitate comparison; this does not imply that an actual semiconductor structure contains all these optical elements. Among the optical devices with heating structures configured to heat the waveguide, it is applicable to form the capping oxide structure as disclosed in some embodiments of the present disclosure. For example, an optical modulator or a phase shifter can have a capping oxide structure with features illustrated in previously shown embodiments. In optical devices that do not have a heating structure, such as a photodetector, a standalone waveguide, or a grating coupler for optical I/O, there is no need to form the capping oxide structure since there is no heating structure in the first place.

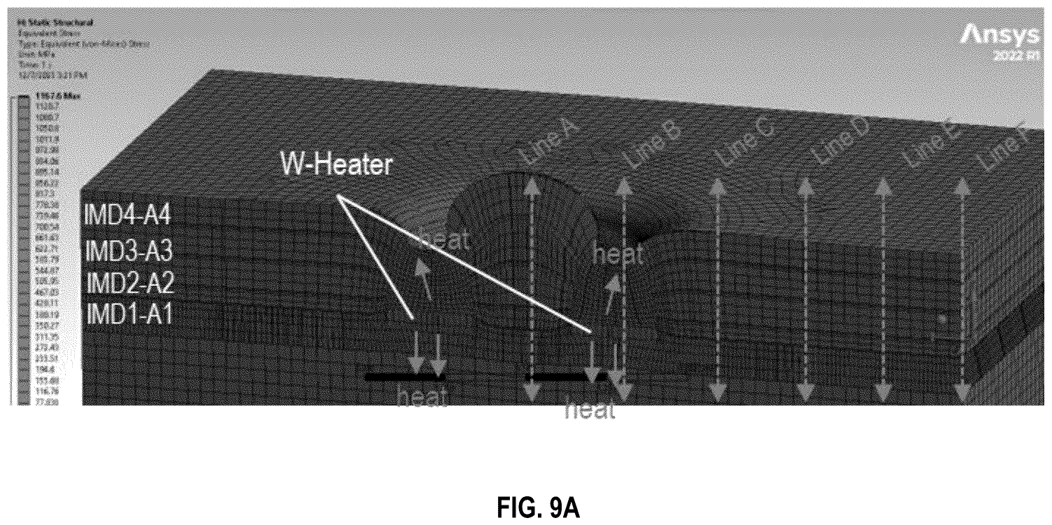

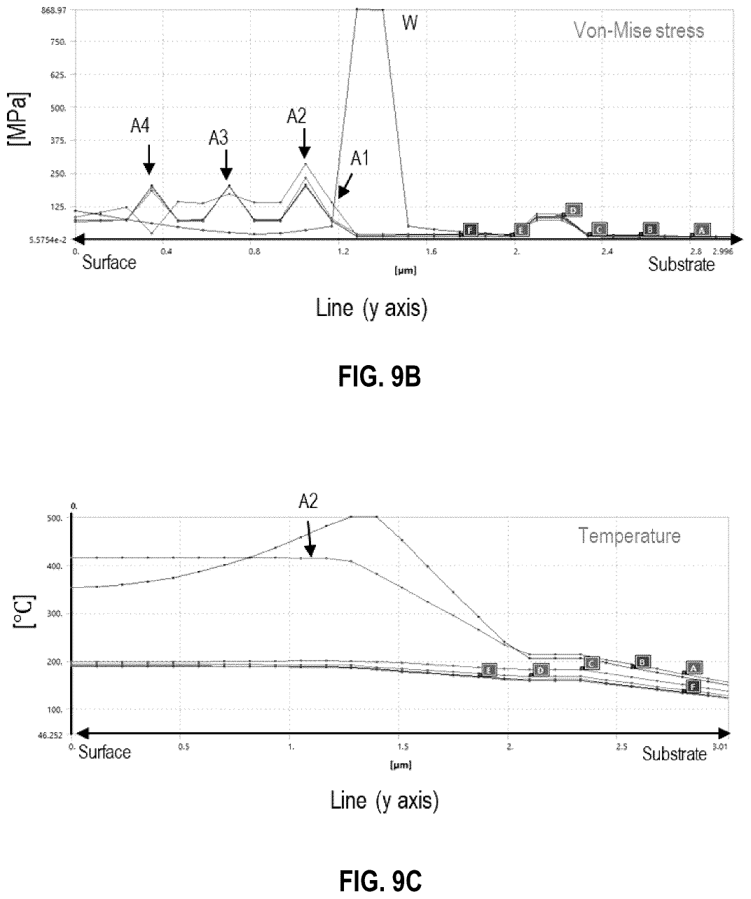

Referring to FIGS. 9A to 9C, which illustrate the simulation result of the equivalent (von-Mises) stress and temperature of a semiconductor structure that having a capping oxide structure over the waveguide and the heating structure. In the scenario where the BEOL structure in the semiconductor comprises multiple IMD layers/films, such as IMD1, IMD2, IMD3, and IMD4 in the stress simulation diagram in FIGS. 9A to 9C, which are labeled as A1, A2, A3, and A4 in the line graph of the stress, the maximum stress at each region of A1 to A4 is much lower than in a comparative embodiment where no capping oxide structure is disposed over the waveguide and the heating structure. For example, in the comparative embodiment, the maximum stress within the region A1 to A4 could be at a level of about 200 MPa, 560 MPa, 300 MPa, and 300 MPa, respectively. In contrast, in the embodiment where a capping oxide structure is disposed over the waveguide and the heating structure, the maximum stress within the region A1 to A4 could be at a level of about 130 MPa, 300 MPa, 200 MPa, and 200 MPa, respectively. Therefore, the concern of structural defects (e.g., cracks in the interface of the layers/films) in the BEOL structure can be greatly alleviated. The simulation results also show that the oxide capping structure can reduce the temperature in the BEOL structure when the heating structure is working as usual. For instance, a temperature in the region A2 can be lowered from about 495° C. to about 420° C. in some examples.

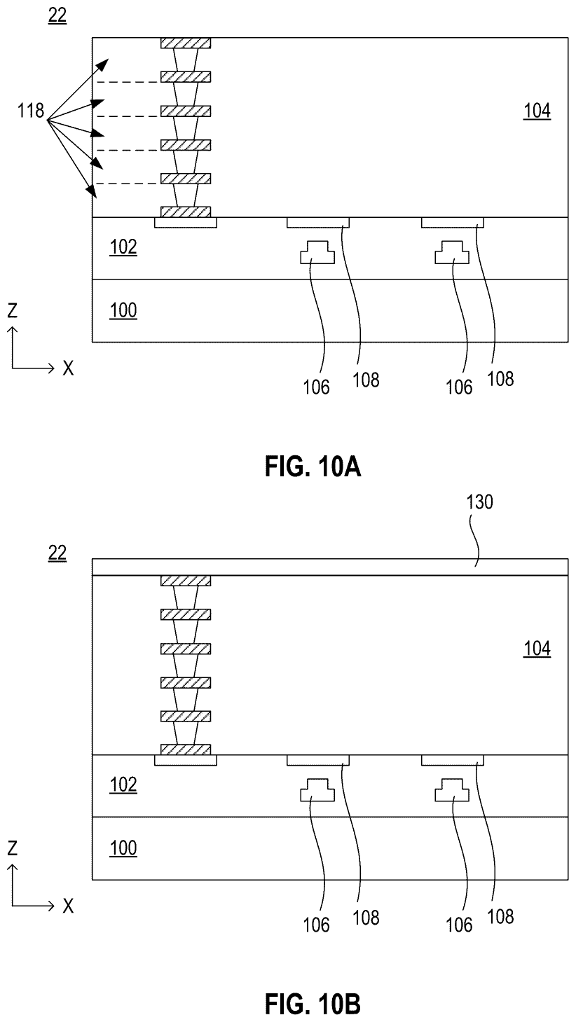

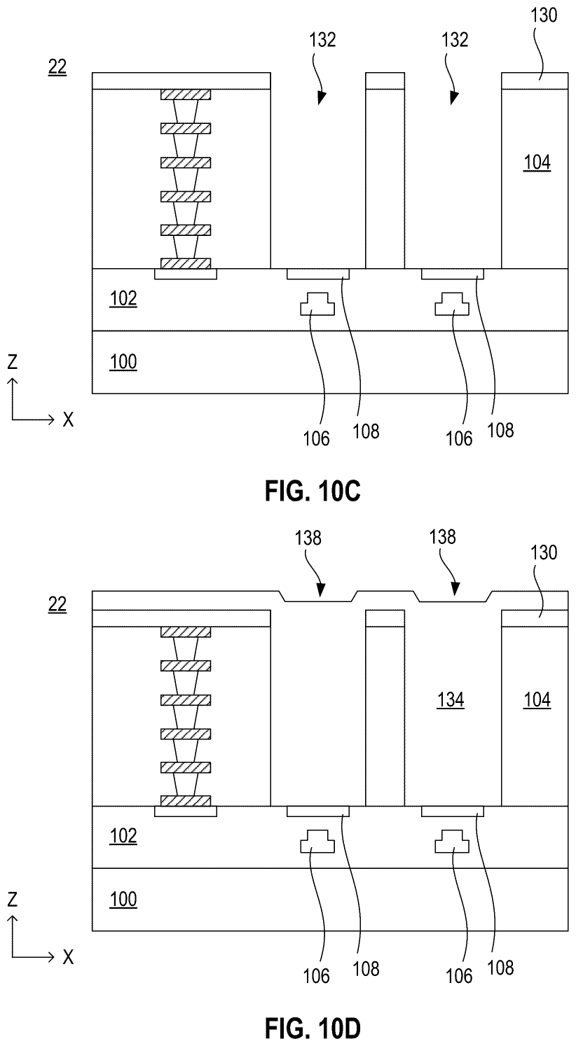

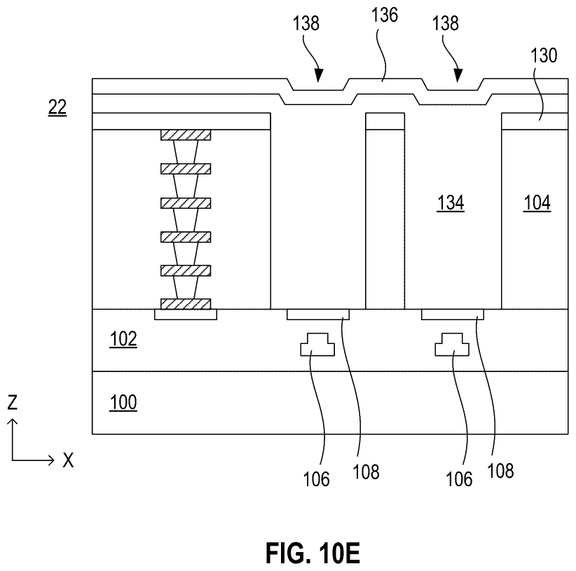

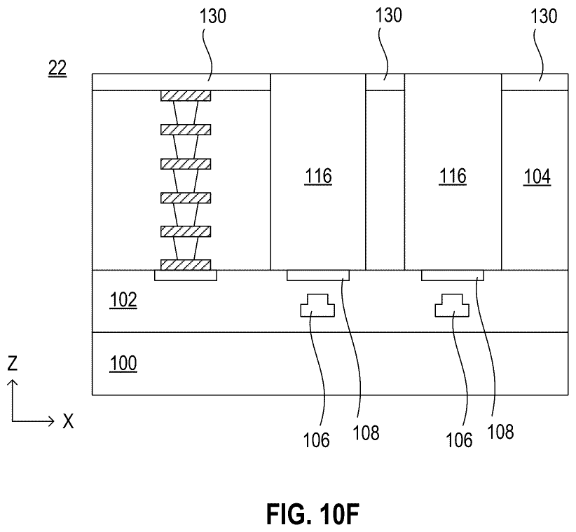

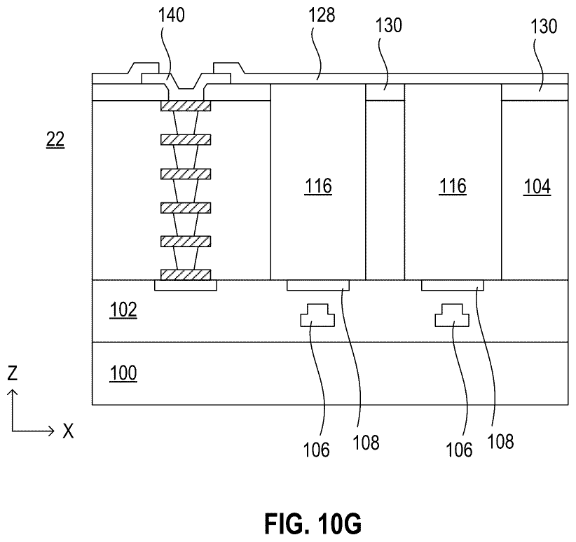

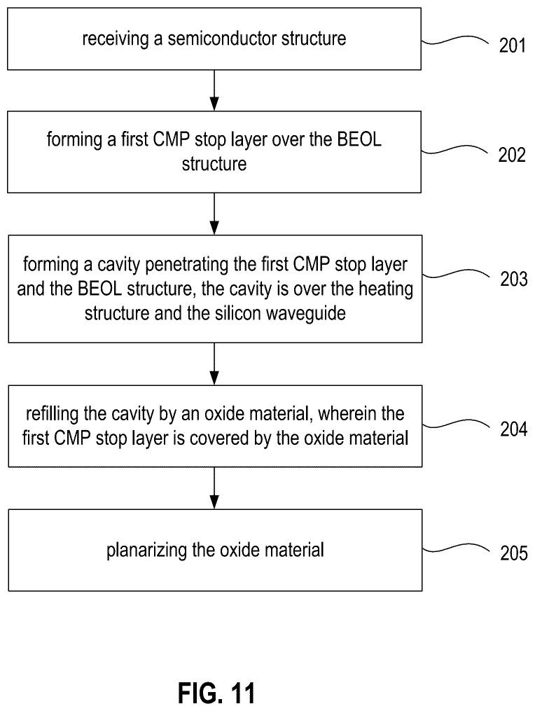

Referring to FIGS. 10A to 10G and FIG. 11, in the method for manufacturing the semiconductor structure having the capping oxide structure as shown in aforementioned embodiments, the operations can including the followings. As illustrated in FIG. 10A and FIG. 11, in some embodiments, a semiconductor structure 22 is received for forming the capping oxide structure therein (i.e., the operation 201). In some embodiments, the semiconductor structure 22 includes a substrate 100, a pre-metal dielectric (PMD) 102 over the substrate 100, and a back-end-of-line (BEOL) structure 104 over the PMD 102. The PMD 102 includes a waveguide 106 and a heating structure 108 located therein. In some embodiments, the BEOL structure 102 includes a plurality of intermetal dielectric (IMD) layers 118 having conductive lines and conductive vias therein for interconnection. In some embodiments, each of the IMD layers 118 are substantially a composite film/layer that includes various materials like TEOS oxide, low-k material, metal glue layer, and etching/CMP stop layer, or the like.

Referring to FIG. 10B and FIG. 11, a first CMP stop layer 130 is formed over the BEOL structure 104 (i.e., the operation 202). In some embodiments, a material of the first CMP stop layer 130 can include silicon nitride. In some embodiments, the first CMP stop layer 130 can be formed over the BEOL structure 104 through a blanket deposition operation.

Next, referring to FIG. 10C and FIG. 11, in some embodiments, one or more cavities 132 can be formed in the BEOL structure 104 through an etching operation (i.e., the operation 203). These cavities 132 are formed over the waveguide 106 and the heating structure 108, and in the scenario that the heating structure 108 includes metal heater, a top surface of the heating structure 108 is exposed by forming the cavity 132. On the other hands, the region(s) of the BEOL structure 104 for forming the cavity 132 is free of having conductive materials (e.g., metal lines, metal vias, passive devices, etc.) to ensure the integrity of the cavity 132 and the integrity of the later formed capping oxide structure. In some embodiments, a side of each of the IMD layers 118 in the BEOL structure 104 can be exposed at the side of the cavity 132. In some embodiments, an aspect ratio of the cavity 132 is no greater than about 5.

In other embodiments, in the scenario that the heating structure 108 is in a form of poly silicon heater (not shown in FIG. 10C), the heating structure 108 is under the cavity 132 but would not be exposed at a bottom of the heating structure 108.

Referring to FIG. 10D and FIG. 11, in some embodiments, the cavities 132 can be refilled by a dielectric material, such as an oxide material 134 (i.e., the operation 204). The oxide material can 134 include tetra-ethyl-ortho-silicate (TEOS), undoped silicate glass (USG), phosphor-silicate glass (PSG), or high-density plasma (HDP) oxide. In some embodiments, the oxide material 134 can include CVD oxides that have good gap-filling capabilities. In some embodiments, the oxide material 134 can be formed in the cavities 132 and over the first CMP stop layer 130 through a blanket deposition operation.

Referring to FIGS. 10E and 10F and FIG. 11, in some embodiments, a second CMP stop layer 136 can be formed over the oxide material 134 (see FIG. 10E), prior to the operation of planarizing the oxide material (see FIG. 10F) (i.e., the operation 205). The second CMP stop layer 136 is formed to control the profile of the top surface of the later formed capping oxide structure. That is, as shown in FIG. 10D, the oxide material 134 may include one or more dishing profiles 138 after refilling the one or more cavities 132. And these dishing profiles 138 over the original positions of the cavities 132 may affect the flatness of the capping oxide structure and the layers formed thereon in the subsequent operations. Therefore, the second CMP stop layer 136 can be formed to control the speed of planarization over the original positions of the cavities 132. That is, since the one or more dishing profiles 138 are covered by the second CMP stop layer 136, the second CMP stop layer 136 may slow down the speed of planarization over the original positions of the cavities 132, compared to the region that is free of the dishing profiles 138. (That is, the second CMP stop layer 136 conformal to the dishing profiles 138 may substantially provide a thicker CMP stop material.) Therefore, after the operation of planarization, the thus formed capping oxide structure 116 can be free of having a dishing profile as that previously presented in the blanket deposited oxide material 134. As shown in FIG. 10F, a top surface of the oxide material (i.e., the capping oxide structure 116) is coplanar to a top surface of the first CMP stop layer 130 after planarizing the oxide material.

Referring to FIG. 10G, in some embodiments, within an interconnect region (e.g., the region other than having the capping oxide structure 116) of the BEOL structure 104, a UBM 140 can be formed at the first CMP stop layer 130 and in contact with the interconnect structure in the BEOL structure 104 (e.g., a top metal layer). Then, a passivation layer 128 in contact with the top surface of the capping oxide structure 116 and the top surface of the first CMP stop layer 130.

Overall, some embodiments of the present disclosure provide a semiconductor structure that includes a capping oxide structure over a waveguide and a heating structure. The heat applied to the waveguide from the heating structure may induce structural defects in the BEOL structures. This is because the BEOL structures typically include composite films/layers made of different materials with different material properties, leading to thermal mismatch. The capping oxide structure, which includes a single oxide material and penetrates the BEOL structure, can help remove the thermal mismatch in the composite films/layers, resulting in better micro heater reliability performance and a wider temperature tuning range.

In one exemplary aspect, a semiconductor structure is provided. The semiconductor structure includes a substrate, a waveguide, a heating structure, a back-end-of-line (BEOL) structure, and a capping oxide structure. The waveguide is over the substrate. The heating structure is over the waveguide. The BEOL structure is over the waveguide. The capping oxide structure in the BEOL structure and covers the heating structure. The capping oxide structure includes a continuous sidewall extended from a top side of the BEOL structure to a bottom side of the BEOL structure.

In another exemplary aspect, a semiconductor structure is provided. The semiconductor structure includes a substrate, a dielectric layer, a back-end-of-line (BEOL) structure, and a capping structure. The dielectric layer is over the substrate. The dielectric layer includes a least a heating structure over the substrate; and a semiconductor waveguide adjacent to the heating structure. The BEOL structure is over the dielectric layer. The capping structure in the BEOL structure and covering the semiconductor waveguide and the heating structure. The capping structure comprises a single type of material and is free of conductive material embedded therein.

In yet another exemplary aspect, a method for forming a semiconductor structure having a capping oxide structure is provided. The method includes the operations as follows. A semiconductor structure is received, wherein the semiconductor structure includes a substrate, a dielectric layer over the substrate, comprising a heating structure and a waveguide, and a back-end-of-line (BEOL) structure over the dielectric layer. A first CMP stop layer is formed over the BEOL structure. A cavity penetrating the first CMP stop layer and the BEOL structure is formed, wherein the cavity is over the heating structure and the waveguide. The cavity is refilled by an oxide material, wherein the first CMP stop layer is covered by the oxide material. The oxide material is planarized.

The foregoing outlines structures of several embodiments so that those skilled in the art may better understand the aspects of the present disclosure. Those skilled in the art should appreciate that they may readily use the present disclosure as a basis for designing or modifying other operations and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A semiconductor structure, comprising:
a substrate;
a waveguide over the substrate;
a heating structure over the waveguide;
a back-end-of-line (BEOL) structure over the waveguide; and
a capping oxide structure in the BEOL structure and covering at least a part of the heating structure, wherein the capping oxide structure comprises a continuous sidewall extended from a top side of the BEOL structure to a bottom side of the BEOL structure.

2. The semiconductor structure of claim 1, wherein the heating structure comprises a micro ring metal heater or a liner metal heater.

3. The semiconductor structure of claim 1, wherein a width of the capping oxide structure is greater than a width of the heating structure.

4. The semiconductor structure of claim 1, further comprising a pre-metal dielectric (PMD) over the substrate, wherein the waveguide and the heating structure are disposed in the PMD.

5. The semiconductor structure of claim 4, wherein an angel between the PMD and the sidewall of the capping oxide structure is in a range from about 80 degrees to about 90 degrees.

6. The semiconductor structure of claim 1, wherein the BEOL structure comprises a plurality of inter metal dielectric (IMD) layers, a side of each of the IMD layers is in contact with the continuous sidewall of the capping oxide structure.

7. The semiconductor structure of claim 1, further comprising at least a void in the capping oxide structure in proximity to a centerline of the capping oxide structure from a cross-section view perspective.

8. The semiconductor structure of claim 1, wherein the waveguide comprises a PN junction, and the semiconductor structure further comprising:
a first type electrode connected to a side of the waveguide; and
a second type electrode connected to another side of the waveguide, wherein the capping oxide structure is located between the first type electrode and the second type electrode from a cross-sectional perspective.

9. The semiconductor structure of claim 1, wherein the semiconductor structure is a phase shifter.

10. The semiconductor structure of claim 1, further comprising:
a silicon nitride layer over the BEOL structure, wherein a top surface of the silicon nitride layer is coplanar to a top surface of the capping oxide structure; and
a passivation layer over the silicon nitride layer and the capping oxide structure.

11. A semiconductor structure, comprising:
a substrate;
a dielectric layer over the substrate, comprising:
at least a heating structure over the substrate; and
a semiconductor waveguide adjacent to the heating structure;
a back-end-of-line (BEOL) structure over the dielectric layer; and
a capping structure in the BEOL structure and covering the semiconductor waveguide and the heating structure, wherein the capping structure comprises a single type of material and is free of conductive material embedded therein.

12. The semiconductor structure of claim 11, wherein the heating structure comprises two poly silicon heaters in proximity to two sides of the semiconductor waveguide, and a width of the capping structure is greater than a width of a region comprising the two poly silicon heaters.

13. The semiconductor structure of claim 11, wherein an aspect ratio of the capping structure is no greater than about 5.

14. The semiconductor structure of claim 11, wherein the single type of material comprises tetra-ethyl-ortho-silicate (TEOS), undoped silicate glass (USG), phosphor-silicate glass (PSG), or high-density plasma (HDP) oxide.

15. The semiconductor structure of claim 11, wherein a width of the capping structure is greater than about 2 μm.

16. A method for manufacturing a semiconductor structure having a capping oxide structure, the method comprising:
receiving a semiconductor structure comprising:
a substrate;
a dielectric layer over the substrate, comprising a heating structure and a waveguide; and
a back-end-of-line (BEOL) structure over the dielectric layer;
forming a first CMP stop layer over the BEOL structure;
forming a cavity penetrating the first CMP stop layer and the BEOL structure, the cavity is over the heating structure and the waveguide;
refilling the cavity by an oxide material, wherein the first CMP stop layer is covered by the oxide material; and
planarizing the oxide material.

17. The method of claim 16, further comprising:
forming a second CMP stop layer over the oxide material prior to planarize the oxide material.

18. The method of claim 16, wherein a top surface of the oxide material is coplanar to a top surface of the first CMP stop layer after planarizing the oxide material.

19. The method of claim 16, wherein a top surface of the heating structure is exposed by forming the cavity.

20. The method of claim 18, further comprising:
forming a passivation layer in contact with the top surface of the oxide material and the top surface of the first CMP stop layer.
